(19) United States
(12) Patent Application Publication
(10) Pub. No.: US 2007/0176919 A1
(43) Pub. Date: Aug. 2, 2007

(54) Interface

(75) Inventors: Yasuhiro Yamashita, Fukaya-shi (JP); Atsuo Okazaki, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toshiba Matsushita Display Technology Co., Ltd.

(21) Appl. No.: 11/699,361

(22) Filed: Jan. 30, 2007

(30) Foreign Application Priority Data
Jan. 31, 2006 (JP) 2006-023181
Jan. 31, 2006 (JP) 2006-023182

(51) Int. Cl. G09G 5/00; G06F 13/14

(52) U.S. Cl. 345/214; 345/520

(57) ABSTRACT

A controller for switching the operation state of a transmitter portion sets a transmitter portion in which the data amount to be transmitted is larger than a predetermined amount to a high speed mode, sets a transmitter portion in which the data amount to be transmitted is below a predetermined amount and larger than zero to a low speed mode, and sets a transmitter portion in which the data amount to be transmitted is equal to zero to a sleep mode. The power consumption in the transmitter portion in which the data amount to be transmitted is small and the transmitter portion in which the data amount to be transmitted is equal to zero can be suppressed and thus the power consumption can be reduced.

### INCORPORATION BY REFERENCE

The present application claims priority under 35 U.S.C. §119 to Japanese Patent Application Nos. 2006-023181 filed on Jan. 31, 2006 and 2006-023182 filed on Jan. 31, 2006. The content of the application is incorporated herein by reference in their entirety.

### FIELD OF THE INVENTION

The present invention relates to an interface for transmitting an image signal for displaying an image to an image display device.

### BACKGROUND OF THE INVENTION

Recently, a high-speed serial interface such as LVDS (Low Voltage Differential Signaling) or the like has been used for a flat panel display as an image display device such as a liquid crystal display device, a plasma display or the like.

In this type of high-speed serial interface, as disclosed in Japanese Laid-Open Patent Publication No. 2002-108293, for example, a differential operation type analog circuit is used as transmitting means at the output side, and current flows through this analog circuit at all times, so that it is not easy to take a power consumption reducing measure such as reduction of stationary current or the like which is used in a normal CMOS (Complementary Metal Oxide Semiconductor) circuit or the like. Furthermore, the voltage of the transmitting means at the input side is set to a low value, 400 mV, and thus the rate of consumed power based on charging/discharging of a capacity in the transmitting means is originally low. Accordingly, even when the frequency of an image signal input to the transmitting means is cut down, the effect of reducing the power consumption by reducing the frequency of the image signal is not expected because current I flows from the power source Vₚₚ side to the ground side irrespective of the switching frequency of ON/OFF of a switching element of an output portion in a transmitter portion of such a high-speed serial interface.

Furthermore, as one means for reducing the power consumption in a graphic system having a flat panel display and a personal computer PC containing a graphic chip for driving the flat panel display, an interlaced scanning operation for transmitting data from the graphic chip to the flat panel display while interlacing several lines may be used in place of a sequential scanning operation of sequentially transmitting all the scan lines, for example.

Such an interlaced scanning operation is a well-known technique in television or the like, and by transmitting/receiving data while interlacing one line or two lines as in the case of the above operation, the frequency of the circuit, that is, the variation frequency of the state of the circuit can be reduced, and the power consumption in the circuit of the flat panel display can be saved.

Specifically, for example, when the interlaced scanning operation of one jump per three lines is carried out, the data transmission amount is equal to ⅓, and thus the variation frequency of the CMOS circuit is equal to ⅓ and thus there is an effect of reducing the power consumption of the CMOS circuit.

However, such a method is effective for the CMOS circuit because the power consumption of the CMOS circuit is mainly caused by the charging/discharging of load capacity, however, it is not effective for high-speed serial interfaces such as LVDS, etc., like the above case.

Furthermore, it may be considered that the interface circuit portion is stopped during the time when no data is transmitted. However, the response time of the PLL clock circuit is delayed, and there is a problem in DC balance of the transmission path, so that it is not easy to stop the interface at high speed.

Still furthermore, in each of the constructions described above, it is generally necessary to increase the through rate of the input signal of the receiver portion in order to transmit data at high speed, and thus it is required to increase the current of the transmitter portion. Therefore, the power consumption determined by I×V_{DD} occupies most of the power consumption at the interface portion, and the conventional CMOS-based power consumption reducing method for lowering the signal voltage or lowering the signal frequency has no effect on the reduction of the power consumption of the overall circuit.

Likewise, the input portion of a receiver portion uses a differential amplifier, and thus constant current flows through the receiver portion as in the case of the transmitter portion, so that the normal power consumption reducing means based on CMOS likewise has little effect. Furthermore, in order to increase the response speed of the differential amplifier, it is required to increase the current value, and thus the occupation rate of the power consumption of the input portion to the power consumption of the receiver portion is large, so that reduction of the power consumption of this portion is effective for the reduction of the power consumption of the receiver portion.

The present invention has been implemented in view of the foregoing point, and has an object to provide an interface that can reduce power consumption.

### SUMMARY OF THE INVENTION

The present invention includes transmission means of a plurality of channels for transmitting an image signal for displaying an image on an image display device; receiving means of a plurality of channels for receiving the image signal transmitted from the transmission means and outputting the image signal to the image display device side; and operation switching means for switching the operation state of at least one of the transmission means and the receiving means, wherein at least one of the transmission means and the receiving means has a processing mode for subjecting the image signal to predetermined processing, a low speed processing mode for subjecting the image signal to predetermined processing with power lower than the processing mode, and a stop mode for stopping the predetermined processing of the image signal, and the operation switching means sets to the processing mode a channel in which an image signal amount to be processed is larger than a predetermined amount, sets to the low speed processing mode a channel in which the image signal amount to be processed is not more than the predetermined amount and is larger than zero, and sets to the stop mode a channel in which the image signal amount to be processed is equal to zero. The operation switching means for switching the operation state of at least one of the transmission means and the receiving means selectively carries out the switching operation so that the channel in which the image signal amount to be processed is larger than the predetermined amount is set to the processing mode, the channel in which the image signal amount to be processed is not more than the predetermined amount and is larger than zero is set to the low speed processing mode, and the channel in which the image signal amount to be processed is equal to zero is set to the stop mode, whereby the power consumption at channels in which the image signal amount to be processed is small or channels in which the image signal amount to be processed is equal to zero can be suppressed, and thus the power consumption can be reduced.

### BRIEF DESCRIPTION OF THE DRAWINGS

FIG. 1 is a block diagram showing the transmission means side of an interface according to a first embodiment,

FIG. 2 is a block diagram showing the receiving means side of the interface,

FIG. 3 is a diagram showing a bit distribution of image data at a predetermined time interval at the interface,

FIG. 4 is a diagram showing a method for compressing image data at the interface,

FIG. 5 is a diagram showing a graphic system using the interface,

FIG. 6 is a block diagram showing the transmission side of an interface according to a second embodiment of the present invention,

FIG. 7(a) is a diagram showing interlaced scanning at the interface,

FIG. 7(c) is a diagram showing the rearrangement of an image signal at the transmission means,

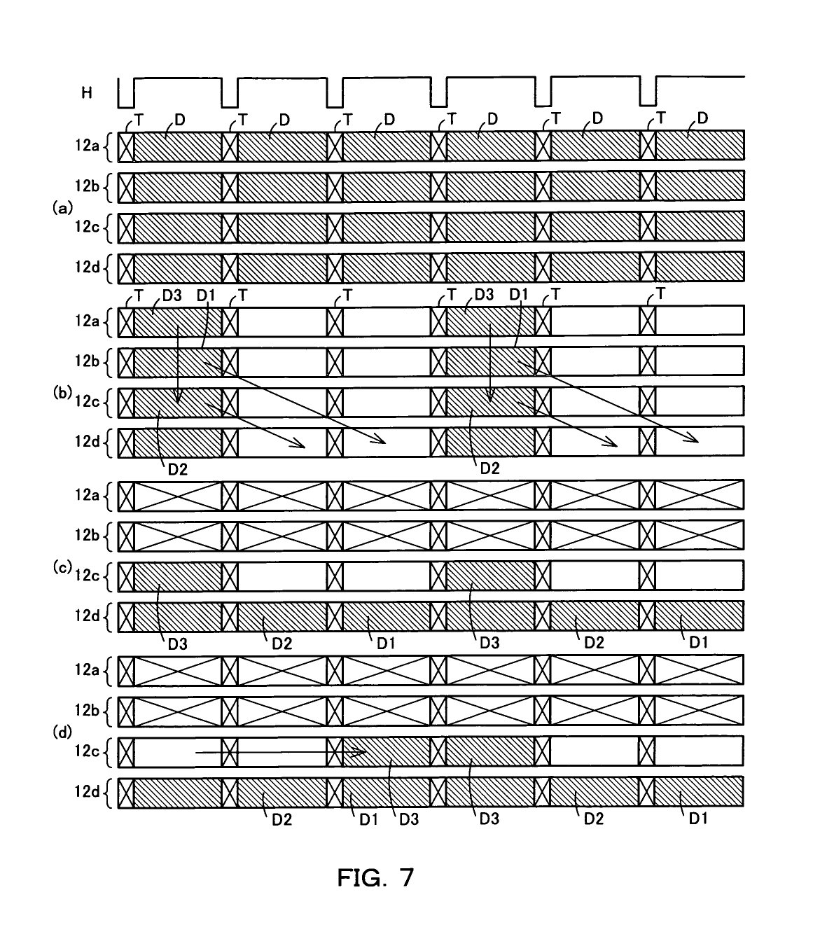

and FIG. 7(d) is a diagram showing the rearrangement of making the image signal sequential in the same channel of the transmission means.

### DETAILED DESCRIPTION OF THE PREFERRED EMBODIMENTS

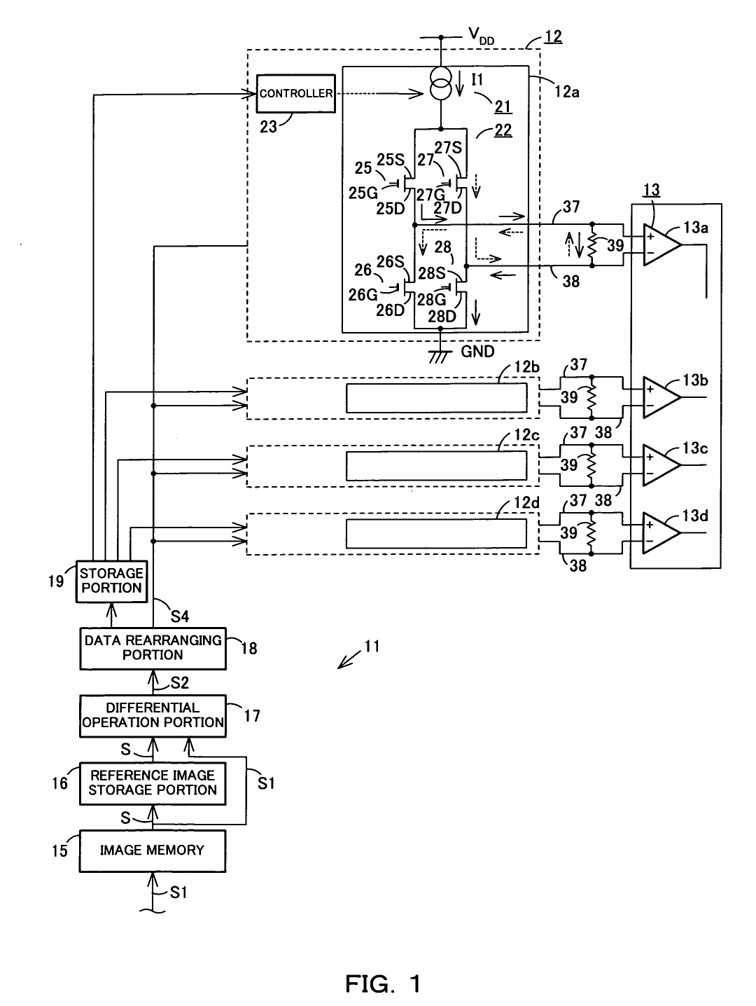

The construction of an interface according to a first embodiment of the present invention will be described with reference to FIGS. 1 to 5.

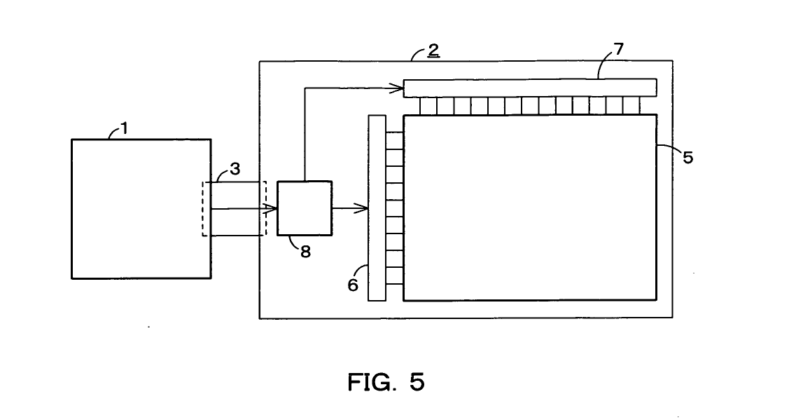

FIG. 5 shows a graphic system. In FIG. 5, 1 denotes a computer, and the computer 1 is electrically connected to an LCD panel 2 corresponding to a liquid crystal display device as an image display device via an interface portion 3 as an interface.

The computer 1 contains a graphic chip (not shown) whose output side is electrically connected to the input side of the interface portion 3.

The LCD panel 2 is an image display device that can perform liquid crystal display and serves as a display unit using thin film transistors (TFT) as switching elements arranged in a matrix form. In the LCD panel 2, a gate driver 6 and a source driver 7 as driver circuits are provided along the side edge and end edge of a rectangular display area 5. The gate driver 6 and the source driver 7 are electrically connected to the gate electrodes and source electrodes of the respective thin film transistors so that the operation of each thin film transistor can be controlled. Furthermore, the LCD panel 2 is provided with a timing controller 8 for switching the control timing of the gate driver 6 and the source driver 7, and also outputting image data transmitted from the graphic chip of the computer 1 via the interface portion 3 at a predetermined timing.

The interface portion 3 is a high-speed serial interface such as LVDS (Low Voltage Differential Signaling) for a liquid crystal display device which displays a predetermined image on the display area of the LCD panel 2. Furthermore, as shown in FIG. 1, an image data outputting circuit 11 corresponding to a drawing engine as image display signal oscillating means which serves as a part of the graphic chip and outputs image data as an image signal is mounted at the input side of the interface portion 3, that is, at the computer 1 side. Furthermore, the interface portion 3 is provided with a plurality of, for example, four transmitter portions 12a to 12d (any one or all of these transmitter portions 12a to 12d may be hereinafter referred to as “transmitter portion 12”) corresponding to a buffer portion as transmitting means for transmitting image data output from the image data output circuit 11 to the LCD panel 2 side, and receiver portions 13a to 13d (any one or all of the receiver portions 13a to 13d may be referred to as “receiver portion 13”) as receiving means for receiving the image data transmitted from the transmitter portion 12 are electrically connected to the respective transmitter portions 12. In FIG. 1, the receiver portion 13 is shown as an operational amplifier for the purpose of convenience.

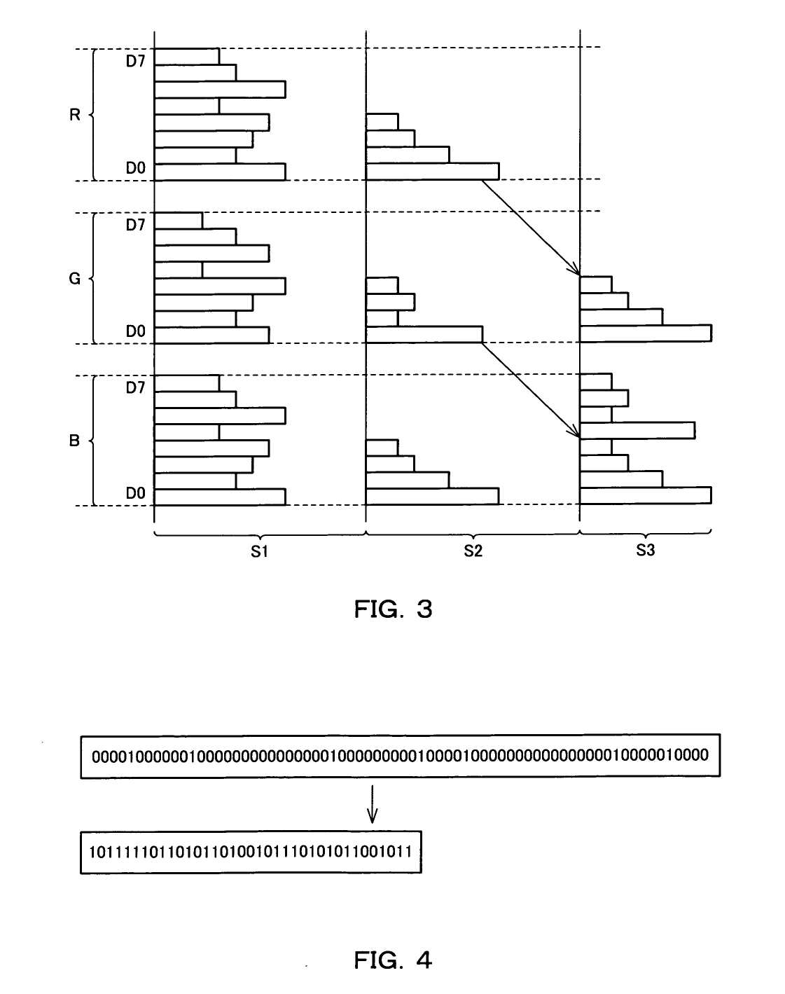

The image data output circuit 11 is equipped with an image memory 15 for storing image display data S1 as an image display signal output from the computer 1 side. Here, as shown in FIG. 3, the image display data S1 stored in the image memory 15 has a red channel R, a green channel G and a blue channel B.

A reference image storage portion 16 for storing reference data S as a predetermined reference signal, for example, image display data S1 of the first one line of an image is electrically connected to the output side of the image memory 15. Furthermore, a differential operation portion 17 as differential operating means for comparing the image display data S1 read out from the image memory 15 with the reference data S stored in the reference image storage portion 16 to calculate the difference therebetween is electrically connected to the output side of the reference image storage portion 16. Furthermore, a data rearranging portion 18 as data rearranging means for rearranging the differential data S2 corresponding to the image data as the image signal output from the differential operation portion 17 according to a predetermined method is electrically connected to the output side of the differential operation portion 17. The data rearranging portion 18 functions as compressing means for coding, that is, compressing the rearranged data S3 (FIG. 3) corresponding to the image data as the rearranged image signal according to a predetermined method, and it can properly allocate and output the image data S4 as the image signal compressed by the above function to each transmitter portion 12. Furthermore, a storage portion 19 is electrically connected to the data rearranging portion 18, and on the basis of the image data S4 output from the data rearranging portion 18, the storage portion 19 stores which transmitter portion 12 is empty for which period.

The transmitter portion 12 is equipped with a power source current adjusting circuit 21 as power source current adjusting means for setting power source current to stationary current, and a transmitter 22 as a channel to which the stationary current from the power source current adjusting circuit 21 is supplied, and the operation of the power source current adjusting circuit 21 is controlled by a control portion 23 as operation switching means, whereby the operation of the transmitter portion 12 can be switched. In FIG. 1, the detailed construction of only the transmitter portion 12a is shown, and the other transmitter portions 12b to 12d are omitted because they have the same construction.

The transmitter 22 has a plurality of, for example, four MOS transistors 25, 26, 27, and 28 as switching elements.

The source electrode 25S corresponding to one electrode of the MOS transistor 25 is electrically connected to the output side of the power source current adjusting circuit 21. The drain electrode 25D corresponding to the other electrode of the MOS transistor 25 is electrically connected to the source electrode 26S corresponding to one electrode of the MOS transistor 26. The drain electrode 26D corresponding to the other electrode of the MOS transistor 26 is grounded and set to the reference potential.

Furthermore, the source electrode 27S corresponding to one electrode of the MOS transistors 27 is electrically connected to the source electrode 25S of the MOS transistor 25, and also electrically connected to the output side of the power source current adjusting circuit 21. The drain electrode 27D corresponding to the other electrode of the MOS transistors 27 is electrically connected to the source electrodes 28S corresponding to one electrode of the MOS transistor 28. The drain electrode 28D corresponding to the other electrode of the MOS transistor 28 is electrically connected to the drain electrode 26D of the MOS transistor 26, and also grounded and set to the reference potential together with the drain electrode 26D of the MOS transistor 26.

Still furthermore, the output side of the data rearranging portion 18 of the image data output circuit 11 is electrically connected to the gate electrodes 25G, 26G, 27G, and 28G as the control electrodes of the respective MOS transistors 25, 26, 27, and 28.

Accordingly, the respective MOS transistors 25, 26, 27, 28 are controlled to be turned on/off in accordance with the image data S4 output from the data rearranging portion 18. That is, these MOS transistors 25, 26, 27, and 28 invert ON/OFF between the MOS transistor 25 and the MOS transistor 28 and between the MOS transistor 26 and the MOS transistor 27 at a predetermined period in the data rearranging portion 18, whereby the signal is alternately inverted in phase as indicated by solid lines and broken lines in FIG. 1.

The control portion 23 is electrically connected to the output side of the storage portion 19, and the current value I1 of the power source current adjusting circuit 21 of each channel can be controlled on the basis of the information of each transmitter portion 12 which is stored in the storage portion 19.

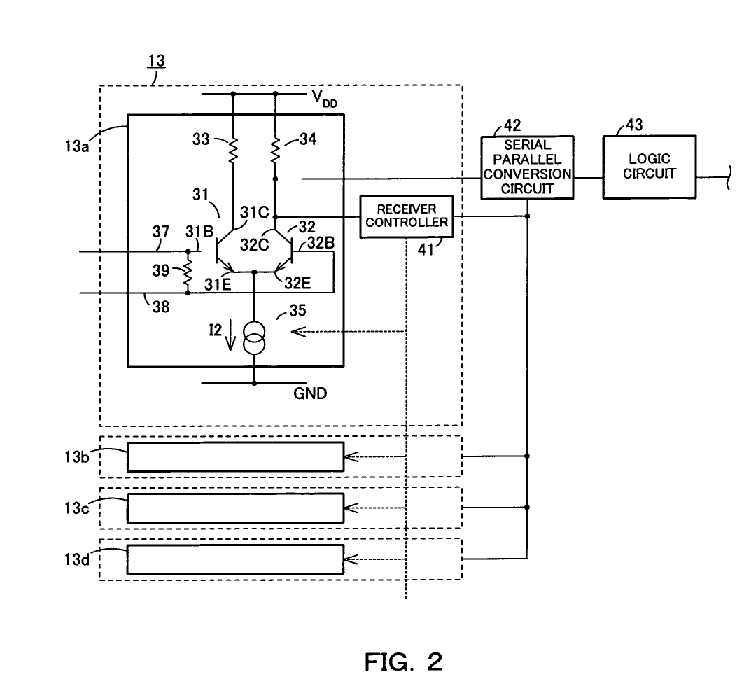

On the other hand, each receiver portion 13 is a differential amplifier provided to the LCD panel 2 side as the output side of the interface portion 3, and provided with transistors 31 and 32 serving as a differential pair, as shown in FIG. 2. Only the receiver portion 13a is shown in detail in FIG. 2, and the other receiver portions 13b to 13d are omitted from the illustration because they have the same construction.

The collector electrodes 31C and 32C of the transistors 31 and 32 are connected to the power source via resistors 33 and 34, and the emitter electrodes 31E and 32E of these transistors 31 and 32 are electrically connected to each other and also electrically connected to the constant current circuit 35. Furthermore, the base electrodes 31B and 32B of the transistors 31, 32 are electrically connected to differential signal lines 37 and differential signal lines 38, respectively.

Here, each differential signal line 37 is electrically connected between the drain electrode 25D of the MOS transistor 25 of each transmitter portion 12 and the source electrode 26S of the MOS transistor 26. Likewise, each differential signal line 38 is electrically connected between the drain electrode 27D of the MOS transistor 27 of each transmitter portion 12 and the source electrode 28S of the MOS transistor 28. A resistor 39 is electrically connected between the differential signal lines 37 and 38.

Furthermore, a receiver control portion 41 as operation switching means is electrically connected between the collector electrode 32C of the transistor 32 and the resistor 34 in each receiver portion 13, and the receiver control portion 41 controls the current value I2 of the constant current circuit 35 to switch the operation of the receiver portion 13. The receiver control portion 41 is electrically connected to the timing controller 8 (FIG. 5) of the LCD panel 2 via a serial parallel conversion circuit 42 for converting a serial signal received in the receiver portion 13 to a parallel signal and a logic circuit 43 for processing image data which is converted to the parallel signal in the serial parallel conversion circuit 42.

Still furthermore, a switching signal of the operation mode in the control portion 23 of each transmitter portion 12 (FIG. 1) is transmitted from the storage portion 19 to the receiver control portion 41 in advance. For example, the switching signal is transmitted by using a signal line independently of the image data output circuit 11 side corresponding to the computer 1 (FIG. 5) side, transmitted during a horizontal or vertical blanking period by a data line of LVDS, or by using a pulse width of a vertical synchronous signal or horizontal synchronous signal.

Information on the data rearranging method in the data rearranging portion 18 (FIG. 1) and the expansion method for compressed data are preset in the serial parallel conversion circuit 42, and the rearranged and compressed image data S4 can be restored again according to the information thus transmitted.

The transmitter portion 12 and the receiver portion 13 have a plurality of operation modes, that is, a high-speed mode as a processing mode for transmitting or receiving the image data S4 at a high speed, a low speed mode as a low speed processing mode for transmitting or receiving image data at a low speed with power consumption lower than the high speed mode by lower clock frequency and transmission band lower than the high speed mode, and a sleep mode as a stop mode for stopping the transmitter portion 12 and the receiver portion 13.

Next, the operation and effect of the above-described first embodiment will be described.

For example, image display data S1 of a red channel R, a green channel G and a blue channel B shown in FIG. 3 which are output from the graphic chip of the computer 1 are first stored in the image memory 15 of the image data output circuit 11, and the data corresponding to the first one line out of the image display data S1 stored in the image memory 15 are stored as reference data S (FIG. 1) in the reference image storage portion 16.

Subsequently, the differential operation portion 17 compares the reference data S stored in the reference image storage portion 16 with the image display data S1 read out from the image memory 15 to generate the differential data S2. The differential data S2 thus generated are output to the data rearranging portion 18, and rearranged data S3 which are rearranged according to a predetermined method are generated.

At this time, when the correlation of the data is high, the differential data S2 concentrates on a lower bit portion, and thus, for example, by rearranging the data of the green channel G to the high bit side of the blue channel B and the data of the red channel R to the low bit side of the green channel G, the red channel R can be made perfectly empty, that is, the data amount which is transmitted by the red channel R can be set to zero.

Furthermore, the green channel G is under the state that the high bit side is empty, that is, the amount of data to be transmitted is small, in other words, data which are almost equal to zero are sequential. Therefore, for example, when seventy pieces of data are transmitted during one horizontal period as shown in FIG. 4, image data S4 (FIG. 1) which are reduced to 37 bits are output by compressing the rearranged data S3 (FIG. 3) according to a run-length method (continuity compression method) or the like.

Furthermore, in the data rearranging portion 18, the image data S4 of the respective channels R, G, B are allocated to the respective transmitter portions 12, and in accordance with this allocation, the transmitter portion 12 in which the amount of data to be transmitted is equal to zero, the transmitter portion 12 in which the data amount is smaller than a predetermined amount and larger than zero, and the transmitter portion 12 in which the amount of data to be transmitted is above a predetermined amount are stored in the storage portion 19 while containing the continuing period of each state.

The control portion 23 controls the current value I1 of the power source current adjusting circuit 21 of each transmitter portion 12 on the basis of the storage of the storage portion 19, whereby the transmitter portion 12 in which the amount of data to be transmitted is large is driven in the high speed mode, the transmitter portion 12 in which the amount of data to be transmitted is small is driven in the low speed mode, and the transmitter portion 12 in which the amount of data to be transmitted is equal to zero is driven in the sleep mode.

At this time, in the example shown in FIG. 4, the clock frequency of the low speed mode is reduced to 37/70≈0.52, that is, it is reduced to about a half clock frequency of the high speed mode, and the transmission band is reduced.

Furthermore, each receiver portion 13 of the interface portion 3 receives the image data S4 transmitted from each corresponding transmitter portion 12. At this time, the operation mode of each receiver portion 13 and the continuing time are set in accordance with the operation mode of each transmitter portion 12 stored in the storage portion 19 and the continuing time thereof.

That is, the current value I2 of the constant current circuit 35 is controlled by the receiver control portion 41 to set the operation mode of each receiver portion 13.

Thereafter, in the serial parallel conversion circuit 42, the image display data S1 is restored from the image data S4 output from the transmitter portion 12 on the basis of the information transmitted from the image data output circuit 11 side in advance, and the serial image display data S1 thus restored are converted to the parallel signal.

The restored image display data S1 is converted to the parallel signal by the serial parallel conversion circuit 42, and then output to the timing controller 8 through the logic circuit 43. Then, the data are output to the gate driver 6 and the source driver 7 at a predetermined timing by the timing controller 8, and prescribed thin film transistors of the LCD panel 2 are driven by the gate driver 6 and the source driver 7, and the image corresponding to the image data is displayed in the display area 5 of the LCD panel 2.

As described above, according to the first embodiment, the control portion 23 for switching the operation state of the transmitter portion 12 detects the amount of data to be transmitted during a constant period in the transmitter portion 12, and dynamically switching the operation mode of the transmitter portion 12 in accordance with the amount of data to be transmitted like the case where the transmitter portion 12 in which the data amount is larger than a predetermined amount is set to the high speed mode, the transmitter portion 12 in which the data amount is not more than the predetermined value and larger than zero is set to the low speed mode whose power consumption is smaller than the high speed mode, and the transmitter portion 12 in which the data amount is equal to zero is set to the sleep mode for stopping, whereby the power consumption in the transmitter portion 12 having the smaller transmission data amount and the transmission portion 12 having the data amount of zero are suppressed, and thus the power consumption can be reduced.

Furthermore, in the receiver portion 13, as in the case of the transmitter portion 12, the receiver control portion 41 dynamically switches the operation mode of the receiver portion 13 in accordance with the amount of data to be processed, whereby the power consumption in the receiver portion 13 in which the data amount to be processed is small and also in the receiver portion 13 in which the data amount to be processed is equal to zero can be suppressed, and thus the power consumption can be reduced more remarkably.

Furthermore, the bits of the differential data S2 operated in the differential operating portion 17 are rearranged in the same transmitter portion 12 and/or between different transmitter portions 12 by the data rearranging portion 18, whereby the differential data can be concentrated on empty bits so that the data transmitted by predetermined transmitter portions 12 can be perfectly set to zero. Accordingly, by dynamically switching the operation mode of the transmitter portion 12 or the receiver portion 13 in accordance with the rearranged data, the power consumption can be reliably reduced in the transmitter portion 12 or the receiver portion 13.

In particular, the differential data S2 concentrates on the lower bit side when the correlation of the image display data S1 is high, and the higher bit side is empty, so that at least one of the plurality of transmitter portions 12 can be set to the low speed mode or the sleep mode by rearranging the differential data S2 between different transmitter portions 12 and thus the power consumption can be reliably reduced.

The data amount to be transmitted can be more remarkably suppressed by compressing the differential data S2 by the function of the compressing means of the differential operation portion 17.

By reducing the clock frequency in the low speed mode, the power consumption of a normal CMOS circuit, etc., associated with the clock frequency can be reduced.

Furthermore, when the switching signal of the operation mode is transmitted from the image data output circuit 11 side during the vertical or horizontal blanking period, or transmitted by using the pulse width of the vertical synchronous signal or the horizontal synchronous signal, it is unnecessary to provide a new signal line between the computer 1 side and the LCD panel 2 side, and there is an advantage in mounting, etc.

In the first embodiment, when the differential data S2 are rearranged in the data rearranging portion 18, the rearrangement may be performed only within R, G, B of each channel or only between R, G, B of respective channels.

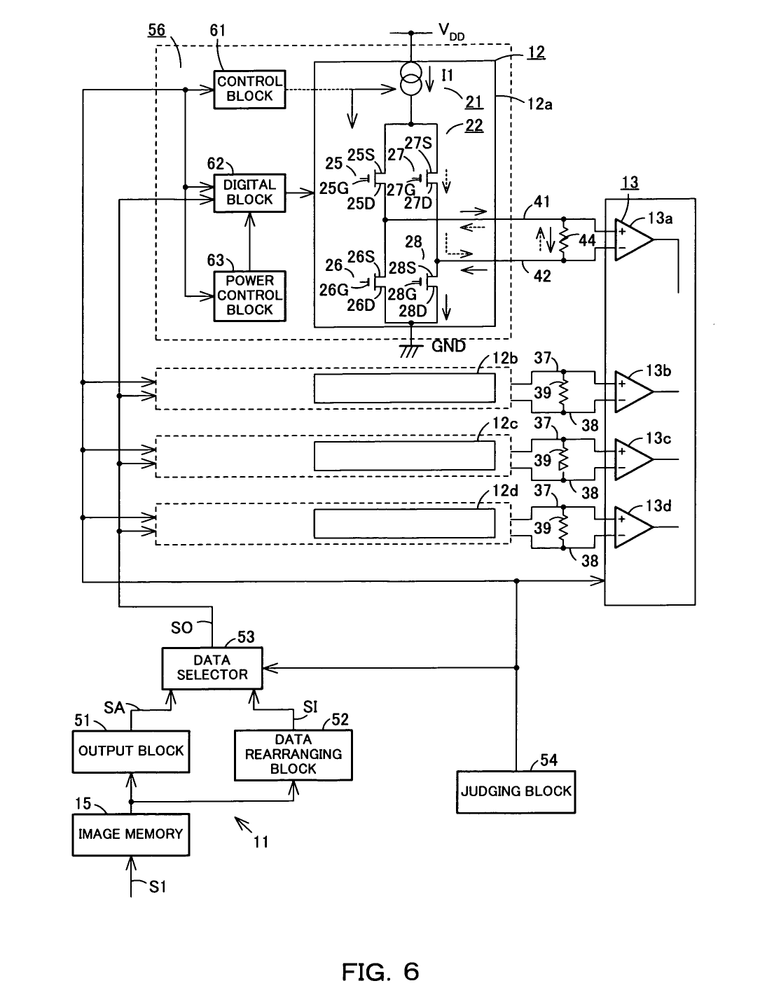

Next, the construction of an interface according to a second embodiment will be described with reference to FIGS. 6 and 7.

In the second embodiment, a so-called interlaced scanning operation in which data are transmitted while interlacing several lines can be performed.

An output block 51 as signal reading means for reading out the image display data S1 stored in the image memory 15 of the image data output circuit 11, and a data rearranging block 52 as data rearranging means for reading out the image display data S1 stored in the image memory 15 are electrically connected to the output side of the image memory 15 of the image data output circuit 11. Furthermore, a data selector 53 as signal selecting means for selecting any output of the output block 51 and the data rearranging block 52 is electrically connected to the output block 51 and the data rearranging block 52. At the data selector 53, a judging block 54 as judging means controls the operation of the image display data S1.

As shown in FIG. 7(a), the output block 51 alternately has a so-called horizontal blanking period T for which data are not transmitted in connection with the low level output of the horizontal synchronous signal (H), and a period for which image display data are scanned over all lines in connection with the high level output of the horizontal synchronous signal (H), temporarily stores read-out image display data, and outputs the data as output data SA (FIG. 6) in conformity with a data format preset for each channel of the transmitter portion 12.

As shown in FIG. 7(b), the data rearranging block 52 has a so-called horizontal blanking period T for which data are not transmitted in connection with the low level output of the horizontal synchronous signal (H), and a period for which image display data are subjected to interlaced scanning while interlacing two lines, that is, every three lines in response to the high level output of the horizontal synchronous signal (H), temporarily stores read-out image display data, rearranges the data according to a predetermined method as shown in FIGS. 7(c) and 7(d) in conformity with a data format preset for each channel of the transmitter portion 12, and outputs the data as output data S1 (FIG. 6). That is, the data rearranging block 52 has the function of scan means.

The judging block 54 judges whether the image display data S1 is a moving picture or still picture, selects any one of the output data SA from the output block 51 and the output data S1 from the data rearranging block 52 in accordance with the above judgment via the data selector 53, and outputs the selected data as output image data SO to the transmitter portion 12 side. Furthermore, the judging block 54 can store the transmitter portion 12 in a state that the data amount to be transmitted is equal to zero, the transmitter portion 12 in which the data amount is smaller than a predetermined amount and also larger than zero, and the transmitter portion 12 in which the data amount to be transmitted is the predetermined amount or more together with the continuing period of each state, and also can output the switching signal of the operation of each transmitter portion 12 on the basis of the stored state of each transmitter portion 12 and the continuing time.

The transmitter portion 12 is controlled by a controller 56 for controlling the operation of the transmitter portion 12 in place of the controller 23 of the first embodiment. In this embodiment, the interface portion 3 is serialized at four times per channel of the transmitter portion 12, and thus it can transmit data of 7 bits per channel, totally 28 bits. That is, it transmits the image display data S1 while allocating 8 bits of each of R, G, B of the image display data S1 per pixel (totally 24 bits), the synchronous signal, and the control signal to each channel.

The output side of the data selector 53 of the image data output circuit 11 is electrically connected to the gate electrodes 25G, 26G, 27G and 28G as the control electrodes of the respective MOS transistors 25, 26, 27, and 28.

Accordingly, ON/OFF of each of the MOS transistors 25, 26, 27, and 28 is controlled in accordance with the output image data SO output from the data selector 53. That is, ON/OFF of these MOS transistors 25, 26, 27, and 28 are inverted at the data selector 53 between the MOS transistor 25 and the MOS transistor 28 and between the MOS transistor 26 and the MOS transistor 27 at a predetermined period, whereby the signal is alternatively inverted in phase as indicated by solid lines and broken lines.

The controller 56 is equipped with a control block 61 as operation switching means, a digital block 62 which is electrically connected to the control block 61, and a power control block 63 which is electrically connected to the control block 61 and the digital block 62.

The control block 61 receives the output of the judging block 54 to control the current value I1 of the power source current adjusting circuit 21, thereby controlling analog portions such as the transmitter 22, a PLL (Phase Locked Loop) clock circuit (not shown), etc.

The digital block 62 is a digital circuit other than the analog portion of the transmitter portion 12.

The power control block 63 receives the output from the judging block 54 to control the power consumption of the digital portions such as the digital block 62, etc., as in the case of the control block 61.

A switching signal for the operation mode in the control block 61 of each transmitter 12 is transmitted to the receiver control portion 41 in advance by the judging block 54 (FIG. 6). This switching signal is transmitted, for example, from the image data output circuit 11 side as the computer 1 side by using a signal line independently, or transmitted during the horizontal or vertical blanking period by using the data line of LVDS, or transmitted by using the pulse width of the vertical synchronous signal or the horizontal synchronous signal.

Furthermore, information on the rearranging method for data in the data rearranging block 52 (FIG. 6) is preset in the serial parallel conversion circuit 42, and the rearranged image display data S1 can be restored again according to the transmitted information.

Next, the action and effect of the second embodiment will be described.

First, the image display data S1 output from the graphic chip of the computer 1 are stored into the image memory 15 of the image data output circuit 11, and the image display data S1 stored in the image memory 15 are sequentially scanned and read out by all the transmitter portions 12 as shown in FIG. 7(a) in the output block 51 and then temporarily stored.

Likewise, the image display data S1 stored in the image memory 15 are read out while subjected to interlaced scanning by the data rearranging block 52, and rearranged and temporarily stored according to a predetermined method.

Here, as shown in FIG. 7(b) and FIG. 7(c), the data rearranging block 52 rearranges the image data D1 and D2 of the transmitter portions 12b and 12c to lines of the transmitter portion 12d in which the interlaced scanning operation is carried out, the image data D3 of the transmitter portion 12a is rearranged to the transmitter portion 12c, and the data amount transmitted by the transmitter portion 12a and the transmitter portion 12b is set to zero over one vertical period.

Furthermore, as shown in FIG. 7(d), the image data D3 which are rearranged from the transmitter portion 12a to the transmitter portion 12c are rearranged in the transmitter portion 12c so as to be continuous with another image data D3.

Subsequently, the judging block 54 judges whether the image display data S1 is a moving picture or still picture. If it is judged that the image display data S1 is a moving picture, the judging block 54 selects the output data SA from the output block 51 via the data selector 53, and if the image display data S1 is a still picture, the judging block 54 selects the output data S1 from the data rearranging block 52 via the data selector 53. Then, the judging block 54 outputs the selected data as the output image data SO.

In the judging block 54, the judging block 54 stores the transmitter portion 12 in a state in which the data amount to be transmitted is equal to zero, the transmitter portion 12 in a state in which the data amount is smaller than a predetermined amount and larger than zero, and the transmitter portion 12 in a state in which the data amount to be transmitted is the predetermined amount or more, together with the continuing period of each state.

The output image data SO selected by the data selector 53 are output to the digital block 62 of each transmitter portion 12.

At this time, on the basis of the switching signal from the judging block 54, the control block 61 of each transmitter portion 12 controls the current value I1 in the power source current adjusting circuit 21, and sets the transmitter portion 12 to the high speed mode, the low speed mode or the sleep mode in accordance with the data amount transmitted from each transmitter portion 12.

Specifically, when the image display data S1 is a still picture, the transmitter portions 12a and 12b in which the data amount to be transmitted is equal to zero are set to the sleep mode, the transmitter portion 12c is driven in the low speed mode, and the transmitter portion 12d is driven in the high speed mode.

Likewise, on the basis of the switching signal from the judging block 54, the power control block 63 controls the operation mode of the digital block 62, thereby reducing the power consumption in the digital block 62.

Furthermore, each receiver portion 13 of the interface portion 3 receives the output image data SO transmitted from the corresponding transmitter portion 12. At this time, the operation of each receiver portion 13 and the continuing time are set in connection with the operation mode of each transmitter portion 12 and the continuing time thereof which are stored in the judging block 54.

That is, the current value I2 of the constant current circuit 35 is controlled by the receiver controller 41 to set the operation mode of each receiver portion 13. In this embodiment, the receiver portions 13a and 13b are set to the sleep mode, the receiver portion 13c is set to the low speed mode, and the receiver portion 13d is set to the high speed mode.

Thereafter, in the serial parallel conversion circuit 42, on the basis of the information pre-transmitted from the image data output circuit 11 side, the image display data S1 is restored from the output image data SO output from the transmitter portion 12, and also the restored serial image display data S1 is converted to a parallel signal.

Then, the restored image display data S1 is converted to the parallel signal in the serial parallel conversion circuit 42, passed through the logic circuit 43 and output to the timing controller 8. Then, the data concerned are output to the gate driver 6 and the source driver 7 at a predetermined timing by the timing controller 8, and prescribed thin film transistors of the LCD panel 2 are driven by the gate driver 6 and the source driver 7, and the image corresponding to the image display data S1 is displayed in the display area 5 of the LCD panel 2.

As described above, according to the second embodiment, the image data are rearranged by the data rearranging block 52 to scan lines over which scanning is jumped in the interlaced scanning operation, etc., whereby the image data are concentrated onto some of the transmitter portions 12. In addition, the control block 61 for switching the operation state of the transmitter portion 12 detects the data amount to be transmitted for a constant period in the transmitter portion 12, and it dynamically switches the operation mode of the transmitter portion 12 in accordance with the data amount to be transmitted like it, sets the transmitter portion 12 in which the data amount is larger than a predetermined amount to the high speed mode, sets the transmitter portion 12 having the data amount below the predetermined amount and larger than zero to the low speed mode which is smaller in power consumption than the high speed mode, and sets the transmitter portion 12 having the data amount of zero to the sleep mode for stopping the transmitter portion 12, whereby the power consumption in the transmitter portion 12 in which the data amount to be transmitted is small and the transmitter portion 12 in which the data amount to be transmitted is equal to zero can be suppressed, and thus the power consumption of the interface portion 3 can be effectively reduced.

Furthermore, in the receiver portion 13, the receiver controller 41 dynamically switches the operation mode of the receiver portion 13 in accordance with the data amount to be processed as in the case of the transmitter portion 12, whereby the power consumption in the receiver portion 13 having a smaller data amount to be processed and the receiver portion 13 having no data amount to be processed can be suppressed, and thus the power consumption in the interface portion 3 can be more remarkably reduced.

In addition, the transmitter portion 12 can be reliably made empty over one vertical period, and thus even in the interface portion 3 in which the response time of the PLL clock circuit is relatively delayed or it is not easy to switch the stop and start of the operation of the transmitter portion 12 to each other at high sped because there is some problem in DC balance of the transmission path, a switching time for stopping or starting the operation of the transmitter portion 12 can be sufficiently taken, and the operation of the transmitter portion 12 can be dynamically stopped or started in accordance with the switching of the still image and moving image of the screen image.

Furthermore, in the data rearranging block 52, the image data which are separated in the same transmitter portion 12 are rearranged so as to be continuous with one another, whereby the extra time for starting or stopping the transmitter portion 12 can be expanded, and thus the time for switching the start and stop of the operation of the transmitter portion 12 can be secured.

By reducing the clock frequency in the low speed mode of the transmitter portion 12, the power consumption of the digital block 62, etc., associated with the clock frequency can also be reduced.

In the second embodiment, the interlaced scanning operation is carried out at different intervals from the second embodiment, for example, interlacing one line or two lines.

Furthermore, in each of the above-described embodiments, the same action and effect as the above-described embodiments can be achieved even by switching the operation mode of only one of the transmitter portion 12 and the receiver portion 13 in accordance with the data amount to be processed.

Still furthermore, two different kinds of low speed modes which are different in transmission band and clock frequency may be provided to more minutely control the transmitter portion 12 or the receiver portion 13, whereby the power consumption can be more effectively suppressed.

In each of the above-described embodiments, the high-speed serial interface is described as LVDS. However, the embodiments may be applied to other serial interfaces such as TMDS (Transition Minimized Differential Signaling), etc.

Still furthermore, any method other than the above-described method may be set as the method for rearranging the image data in the data rearranging portion 18 and the data rearranging block 52 insofar as it can efficiently reduce the power consumption of the transmitter portion 12.

Still furthermore, the LCD panel 2 is used as the image display device, however, an organic EL display device or the like may be applied.

What is claimed is:

1. An interface comprising:
transmission means of a plurality of channels for transmitting an image signal for displaying an image on an image display device;
receiving means of a plurality of channels for receiving the image signal transmitted from the transmission means and outputting the image signal to the image display device side; and
operation switching means for switching the operation state of at least one of the transmission means and the receiving means, wherein at least one of the transmission means and the receiving means has a processing mode for subjecting the image signal to predetermined processing, a low speed processing mode for subjecting the image signal to predetermined processing with power lower than the processing mode, and a stop mode for stopping the predetermined processing of the image signal, and the operation switching means sets to the processing mode a channel in which an image signal amount to be processed is larger than a predetermined amount, sets to the low speed processing mode a channel in which the image signal amount to be processed is not more than the predetermined amount and is larger than zero, and sets to the stop mode a channel in which the image signal amount to be processed is equal to zero.

2. The interface according to claim 1, further comprising differential operation means for calculating the difference between an image display signal for displaying an image on the image display device and a predetermined reference signal and outputting an image signal, wherein at least one of the transmission means and the receiving means executes predetermined processing on the image signal output from the differential operation means.

3. The interface according to claim 1, further comprising data rearranging means that can rearrange bits of the image signal at least either in the same channel or between different channels, wherein at least one of the transmission means and the receiving means executes predetermined processing on the image signal rearranged by the data rearranging means.

4. The interface according to claim 1, further comprising compression means for compressing the image signal, wherein at least one of the transmission means and the receiving means executes predetermined processing on the image signal compressed by the compressing means.

5. The interface according to claim 1, further comprising scan means that can execute interlaced scanning on the image signal for displaying the image on the image display device, and data rearranging means that can rearrange the image signal which is subjected to the interlaced scanning by the scan means, wherein the transmission means transmits the image signal rearranged by the data rearranging means, and the data rearranging means can rearrange the image signal at least either in the same channel or between different channels.

6. The interface according to claim 5, wherein the data rearranging means can rearrange image signals separated in the same channel so that the image signals are continuous with each other in the same channel.
